(19) United States
(12) Patent Application Publication
(10) Pub. No.: US 2016/0300273 A1
(43) Pub. Date: Oct. 13, 2016

(54) DETERMINING NEAR-CONTINUOUS PROPERTY-LEVEL LOCATION EFFECTS

(71) Applicant: Fannie Mae, Washington, DC (US)

(72) Inventors: Weifeng Wu, Falls Church, VA (US); John Treadwell, Washington, DC (US); Eric Rosenblatt, Derwood, MD (US); Jesse D. Staal, Washington, DC (US); Fotis Gavriil, Vienna, VA (US)

(21) Appl. No.: 14/681,377

(22) Filed: Apr. 8, 2015

(51) Int. Cl. G06Q 30/02; G06F 17/30; G06Q 50/16

(52) U.S. Cl. CPC G06Q 30/0278; G06Q 50/16; G06F 17/30241; G06F 17/3087

(57) ABSTRACT

Continuous property-level location effects may be determined by generating property-level location effect functions that map location coordinates to property-level location effect values. Each property-level location effect function corresponds to a sub-region of a larger region, the larger region being a region to which a hedonic equation of an automated valuation model corresponds. Each of the property-level location effect functions may be generated by fitting a set of data points that correspond to the sub-region for which the function is being generated. The set of data point to which a given function is fitted are based on the differences between model-estimated values and actual values (e.g., sales prices) for each of the properties located in the corresponding sub-region and in at least one adjoining sub-region. The property-level location effects functions are continuous and vary within their respective sub-region according to property-level changes in location effect.

### BACKGROUND

1. Field of the Invention

The present invention relates generally to computer modeling of real estate property values, and more particularly to estimating the effect of location on property values.

2. Description of the Related Art

The value of a house depends on many factors, such as its size, its condition, the number of bedrooms and bathrooms it has, and its location, among many others. Certain approaches to estimating (appraising) the value of real estate attempt to account for how such factors contribute to the overall value of properties in general (e.g., how much value does an extra bathroom contribute to a house's total value?), and then use this information to estimate a value of a subject property based on the characteristics of the subject property. This is often done by determining properties that are similar to the subject property and have recently sold (comparable properties), and then basing the estimated value of the subject property on the sale prices of the comparable properties. However, since the comparable properties are unlikely to be exactly the same as the subject property, the prices of the comparables can be adjusted based on the differences in characteristics.

In order to increase the accuracy of such estimations of value, computer modeling may be used to determine quantitatively how much the various factors contribute to property value. For example, a statistical regression may be performed using property data from all of the properties recently sold in a geographic region (e.g., all of the properties in a county), thereby generating a regression equation that models property value in terms of explanatory variables such as house size, number of bedrooms, number of bathrooms, etc. (aka a hedonic equation). Such computer models will be called Automated Valuation Models (“AVMs”) hereinafter. AVMs may be used to directly estimate the value of a subject property by plugging characteristics of the subject property into the hedonic equation. AVMs may also be used as part of a comparable property appraisal approach by, for example, using derived coefficients of the hedonic equation as the adjustment factors for adjusting sale price according to differences in characteristics between the subject property and the comparable properties. AVMs may also be used as part of a comparable property appraisal approach by, for example, using the hedonic equation to automatically identify the best comparable properties for use in appraising a subject property.

One of the most important of the factors that contributes to property value is location—two properties that are essentially equivalent except for their locations may nonetheless have very different values. Indeed, location can account for a substantial proportion of a home's overall value, and thus must be taken into account by AVMs for accurate modeling.

AVMs have previously attempted to take location into account in various ways. For example, in one approach the hedonic equation for a geographical region includes a categorical location effect variable for sub-regions of the area. This approach produces an average location effect value for each sub-region, which can be used in the hedonic equation to estimate location effects for the properties located in the sub-region. Location effect here refers to the amount that location contributes to the overall value of a property (i.e., the portion of a property's overall value that can be attributed solely to its location).

In another approach, instead of generating one hedonic equation for a geographic region such as a county, multiple separate hedonic equations are generated for smaller sub-regions, such as census tracts.

Other approaches to accounting for location effects include attempting to separate out various components of location itself, and then including these components of location as separate variables in the hedonic equation. For example, the value of a property's location may be a complex function of many factors, such as whether the location affords a scenic view, the visual appearance of the area surrounding the location (e.g., do the neighbors have well-kept yards?), and the proximity of the location to various desirable places (e.g., proximity to oceanfront, greens spaces, central business districts, transit hubs, amenity hotspots, etc.), to name a few. Thus, for example, one approach may add an independent variable to the hedonic equation that specifies the distance between the property and a central business district, in the hopes that this variable will address at least some portion of the amount contributed to overall value by the property's location.

### SUMMARY

The above-noted approaches to accounting for location effect have various difficulties. For example, generating separate hedonic equations for each sub-region may result in each hedonic equation being drawn from an insufficient number data points, thereby reducing their reliability. More fundamentally, many of these approaches share the limitation that they rely upon discrete neighborhood-level statistics, which may fail to distinguish intra-neighborhood differences in location effect. Some locations in a neighborhood may be much more desirable than other location in the same neighborhood, which means that the actual location effect for some properties in a neighborhood may be very different from the actual location effect for other properties in the same neighborhood. These intra-neighborhood variations can be quite substantial, but are not reflected in the above-approaches.

Consider, for example, the sub-region average location effect approach. The actual location effect for some properties in the sub-region may differ greatly from the sub-region's average location effect; for such properties, the sub-region average location effect is a poor estimate of location effect. Because location is such an important factor in overall value, such inaccuracies in the estimated location effect for a property translate into inaccuracies in the estimation of overall value for the property. The differences between actual and average location effect within a single sub-region can be quite dramatic for some properties, which means that estimations that rely upon the sub-region average location effect can be very inaccurate for some properties. Thus, while knowing the average location effect of a sub-region may be useful in certain circumstances, it may not provide a sufficiently accurate estimation of location effect for each of the properties within the sub-region.

In addition, many of the approaches discussed above result in abrupt discontinuities at the boundaries of the sub-regions. For example, at the boundary between two sub-regions, the sub-region average location effect abruptly jumps from one value to a different value. However, in actuality two locations near the boundary but on opposite sides thereof may not be very dissimilar at all, and thus the actual location effect on either side of the boundary should be very similar for these locations. In other words, in actuality there is often a smooth transition in location effect as you cross a sub-region boundary, but when using the sub-region average location effect approach there is an abrupt jump instead of the smooth transition. These discontinuities may result in poor estimation of property values near sub-region boundaries.

Approaches that attempt to separate out components of location itself may have additional limitations. For example, in order to account for the entire location effect by this approach, one would need to identify each component of location that contributes to value and include a variable for each such factor. However, it is often difficult to know just what the components that contribute to location effect are, much less how much those components contribute to location effect. Further, accounting for characteristics that are not universal across the entire population (e.g., oceanfront, public transit, mountain view, etc.) can be labor intensive to the point of impracticality.

The present disclosure solves the above noted problems by providing methods, computer applications, and computing systems for determining property-level location effects.

According to one exemplary embodiment of the present disclosure, a non-transitory computer readable medium may be provided that stores program code for determining property-level location effects. The program code may be configured to, when executed by a computing system, cause the computing system to perform operations comprising: accessing property data that describes properties located in a geographic region that includes various sub-regions; determining, based on the property data, a regression function that models a relationship between sale price and a set of explanatory variables that includes a sub-region-level location fixed effect variable; determining an estimated value for each of the properties by using the regression function; determining a property-level location effect for each of the properties based on a difference between the estimated value determined for the respective property and a realized sale price of the respective property; determining, for each of the properties, a location effect data point that includes coordinates that specify a location of the respective property and the property-level location effect determined for the respective property; and determining, for each of the sub-regions, a property-level location effect function that relates location effect as a dependent variable to one or more independent variables that specify location by regressing over the location effect data points of at least those of the properties that are located in the respective sub-region, the property-level location effect function varying in value within the respective sub-region.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a conceptual diagram illustrating a computing system 100.

FIG. 2 is a conceptual diagram illustrating region 200 and sub-region average location effects l̅ᵢ for sub-regions 201.

FIG. 3 is a process flow diagram illustrating a process for generating property-level location effect functions.

FIG. 4 is a process flow diagram illustrating continuing the processes of FIG. 3.

FIG. 5 is a graph of exemplary data points.

FIG. 6 is a graph of a continuous function fit to the data points of FIG. 5.

FIG. 7 is a process flow diagram illustrating a process for determining which data points to include in the subset dᵢ.

FIG. 8 is a conceptual diagram illustrating the region 200 and property-level location effect functions ƒᵢ(x,y) for the sub-regions 201.

FIG. 9 is a process flow diagram illustrating a process of estimating a value of a subject property using a modified hedonic equation.

FIG. 10 is a process flow diagram illustrating a process of storing discrete values of the property-level location effect functions.

FIG. 11 is a conceptual diagram illustrating an exemplary gridding of the region 200.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

The present disclosure is related to the estimation of near-continuous location effect functions or gradients for a geographic region, and various applications that may use these location effect functions. The location effect functions relate location coordinates as independent variables to a location effect value as a dependent variable. The location effect value for a given location is a quantitative assessment of how much of the overall value of a hypothetical property located at the given location may be attributed to its being located at the give location. Unlike the sub-region average location effects described above, the location effect function generates location effect values that vary smoothly within a sub-region, reflecting property-level changes in location effects. Moreover, the location effect functions ensure smooth transitions in location effect values at boundaries of sub-regions, unlike the previously tried approaches described above. Thus, the location effect functions allow for, among other things, much more accurate valuations of properties by an AVM.

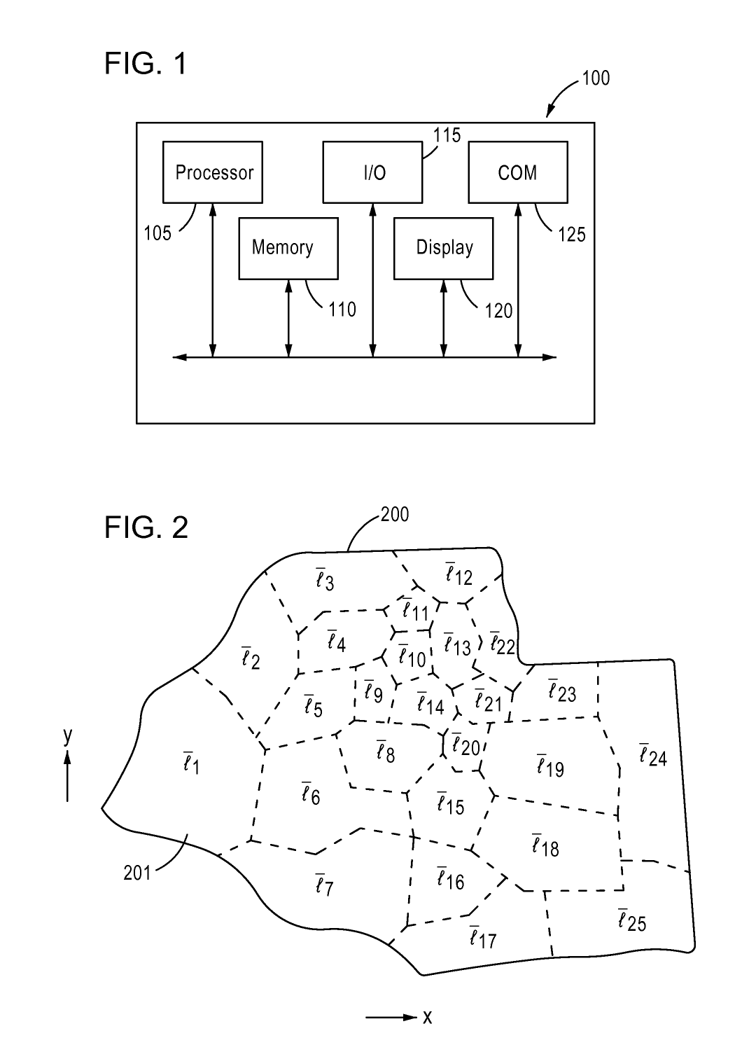

The determination of the location effect functions may be performed by an appropriately configured computing system, such as the computing system 100 illustrated in FIG. 1. A processor 105 may execute program code that is stored on a non-transitory computer readable medium 110, and, when executed, the program code may cause the computing system to perform the various operations described in this disclosure. The computing system may include various components such as input/output components 115, a display 120, and a communications unit 125, as well as other components not discussed in detail herein.

The various operations described herein may be performed in a distributed manner across multiple physically distinct devices. For example, a first device may execute program code that controls determination of the location effects functions and calculation of location effect values therefrom, while a second device in communication with the first device may execute program code that executes an AVM that may use the calculated location effect values. Such distribution of operations across multiple physically distinct devices is well known in the art, and thus detailed description thereof is omitted. Accordingly, it will be understood that when “a computing system” is referred to herein, this may include any number of physically distinct devices that work in concert to perform the recited operations, unless specifically indicated otherwise. For ease of discussion, in the following description operations associated with determining a location effect function will be described with relation to a single location effect application, but it will be understood that this is merely for convenience of description and does not imply any required organization of program code or arrangement of physical devices.

Moreover, when “a non-transitory computer readable medium storing program code thereon” is referred to herein, it will be understood that this may include multiple physically distinct media that each may store some portions of the program code but not necessarily other portions thereof, unless specifically indicated otherwise.

FIG. 2 illustrates a geographical region 200, which is divided into sub-regions 201. The geographical region 200 is preferably large enough to include sufficient property data to generate a reliable hedonic equation. For example, it may be preferable that the geographic region 200 correspond to a county (or region that is roughly equivalent in size to an average county). However, other areas such as a multi-county area, state, metropolitan statistical area, or others may be used. The sub-regions 201 may be any convenient division of the geographic region 200, such as Census Block Groups (CBGs). Other examples of such divisions include Census Tracts, school districts, water districts, and so on. Using a geographical region 200 and/or sub-regions 201 that correspond to regions already defined for other purposes (e.g., political divisions, census divisions, etc.) may beneficially simplify gathering and handling of statistical data, which may already be sorted according to such divisions. However, it is also possible to define new boundaries for the region 200 and sub-regions 201 for purposes of generating the location effects functions.

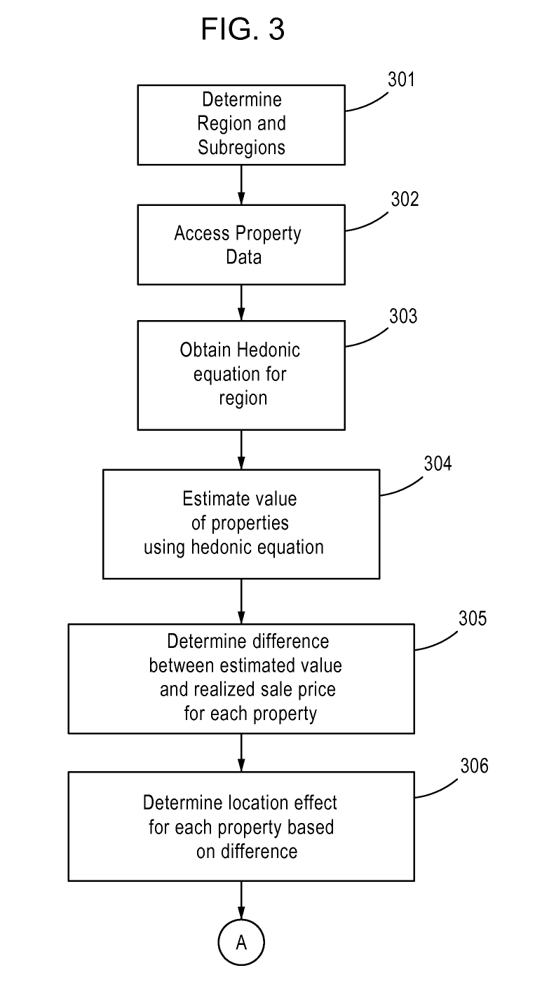

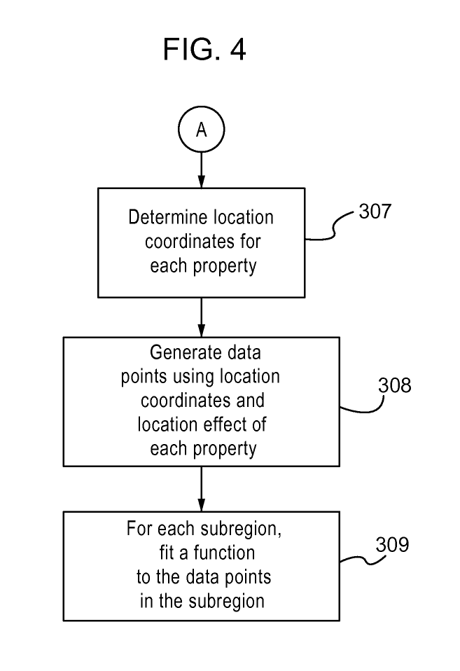

FIGS. 3 and 4 illustrate a process for determining location effect functions. In process block 301, a geographical region is determined and sub-regions thereof are determined. For example, the geographic region 200 of FIG. 2 is determined and the sub-regions 201 are determined.

In process block 302 property data of properties located in the geographic region 200 is accessed. The property data may be data from all properties within the region 200 that have been sold within a predetermined period of time, such as within the last nine months. The property data indicates sale prices, locations, and characteristics of the properties.

In process block 303 a hedonic equation is obtained based on the accessed property data. The hedonic equation may be obtained by performing a regression over the property data that models sale price of the properties in terms of explanatory variables.

An exemplary hedonic equation may include as explanatory variables physical characteristics of the property (such as gross living area, age, number of bedrooms, number of bathrooms), and non-physical characteristics associated with the property (such as condo fees, location specific effects, time of sale specific effects, and property condition effect (or a proxy thereof)). Specifically, in this example the explanatory variables include: gross living area (“g”), age (“a”), number of bathrooms (“b”), and HOA/Condo Fees (“f”), as continuous variables; and number of bedrooms (“BED”), time since sale (“T”) (e.g., measured in calendar quarters counting back from the estimation date), foreclosure status (“FCL”), and a sub-region average location effect (“L̅O̅C̅”) as fixed-effect variables. For convenience in calculation, the hedonic equation may relate the log of price (“p”) to the log of certain explanatory variables, in which case the hedonic equation may have the following form:

$$ln ( p ) = {β}_{g} ln ( g ) + {β}_{a} ln ( a ) + {β}_{b} b + {β}_{f} f + {\sum }_{h}^{ } {BED}_{h} + {\sum }_{i = 1}^{N} {\overline{LOC}}_{i} + {\sum }_{j}^{M} {T}_{j} + {\sum }_{k = \{ 0 , 1 \}}^{ } {FCL}_{k}$$

In the hedonic equation above, h, i, j, and k are indexes, with h corresponding to the number of bedrooms, i identifying the sub-region in which the property is located (N being the total number of sub-regions 201), j indicating how many calendar quarters ago the property was sold (M being the total number of quarters covered by the property data), and k indicating a foreclosure status (e.g., 0=non-foreclosure, 1=foreclosure). The values of the coefficients β_{g}, βₐ, β_{b}, and β_{f} are determined by regressing over the property data, as are the values of the fixed effects BEDₕ, L̅O̅C̅ᵢ, Tⱼ, and FCLₖ. This is merely an example of one possible hedonic model, and the hedonic equation need not necessarily be exactly the same as this example—for example, some hedonic models may omit or add different explanatory variables, define variables differently, use continuous variables in place of fixed-effect variables and vice-versa, etc.

The sub-region average location fixed effect variable L̅O̅C̅ᵢ from the exemplary hedonic equation above corresponds to the sub-region average location fixed effect values that were discussed above with respect to previously tried approaches to addressing location effects. In particular, once the hedonic equation is generated, a value of L̅O̅C̅ᵢ for each sub-region 201 will have been determined, and the value of L̅O̅C̅ᵢ, for a given sub-region 201 is the sub-region average location fixed effect value for the sub-region 201. These sub-region average location fixed effect values are indicated by l̅ᵢ in FIG. 2, with each sub-region 201 having its own sub-region average location fixed effect value l̅ᵢ.

In process step 305 an estimated value V_{q}^{est.} is calculated from the hedonic equation for each property included in the property data. In this notation, q is an index identifying the property. A difference δ_{q} between the actual value V_{q}^{act.} for the property and this estimated value V_{q}^{est.} is determined for each of the properties. The actual value V_{q}^{act.} for the property is a transactionally determined value of the property, such as the price for which the property sold. Thus, in process step 305 the difference δ_{q}=V_{q}^{act.}−V_{q}^{est.} is determined for each value of q (i.e., for each property). Because the hedonic equation may model the log of price against the log of certain explanatory variables, it is also possible for V_{q}^{est.} to correspond to the log of the estimated price and for V_{q}^{act.} to correspond to the log of the actual sales price.

When the hedonic equation includes the sub-region average location effect variable L̅O̅C̅ᵢ (as in this exemplary process), the differences δ_{q} calculated in step 305 represent marginal location effect values—i.e., they represent the marginal difference between the actual location effect for the property and the sub-region average location effect for the sub-region 201 in which the property is located. For example, if the 5^{th} property (q=5) is located in the 2^{nd} sub-region 201 (i=2), then the actual absolute location effect for the property corresponds to δ₅+l̅₂. In other words, the actual location effect for any given property differs from the sub-region average location effect l̅ᵢ of the sub-region 201 in which the property is located by the difference δ_{q} for the property.

However, it is also possible to perform the same process using a hedonic equation that omits the sub-region average location effect variables L̅O̅C̅ᵢ. In this case, the differences δ_{q} calculated in step 305 represent the marginal difference between the actual location effect values for properties and an error term (residual term) of the hedonic equation.

In process step 306 a property-specific location effect λ_{q} is determined for each of the properties based on the difference δ_{q} determined in step 305. The property-specific location effect λ_{q} may simply equal the difference δ_{q} determined in step 305, or it may be related to the difference δ_{q} by some predetermined operations (for example, operations converting the difference into a log format). The differences δ_{q} represent marginal differences in location effect, and thus the property-specific location effects λ_{q} will be marginal location effect values unless converted into absolute location effect values. For example, when the differences δ_{q} calculated in step 305 represent the marginal location effect over the sub-region average location effect, the property-specific location effects λ_{q} may be converted into an absolute location effect value by adding the sub-region average location effect value l̅ᵢ for the sub-region 201 in which the property is located to the difference δ_{q} for the property. Thus, if marginal location effects values are desired, then the property-specific location effects λ_{q} may be determined by λ_{g}=δ_{q}, whereas if absolute location effect values are desired, then the property-specific location effects λ_{q} may be determined by λ_{q}=l̅ᵢ+δ_{q} (where i indicates the sub-regions 201 that contains property q).

The process then continues to step 307 illustrated in FIG. 4. In step 307, two-dimensional location coordinates (x_{q},y_{q}) are determined for each of the properties. For example, longitude and latitude coordinates may be used. However, the coordinate system is not restricted to any one system. For example, a Cartesian coordinate system may be defined relative to any arbitrary point in the region 200. As another example, a polar coordinate system may be defined relative to any arbitrary point in the region 200. In fact, any coordinate system that is capable of identifying a two-dimensional location within the region 200 can be used.

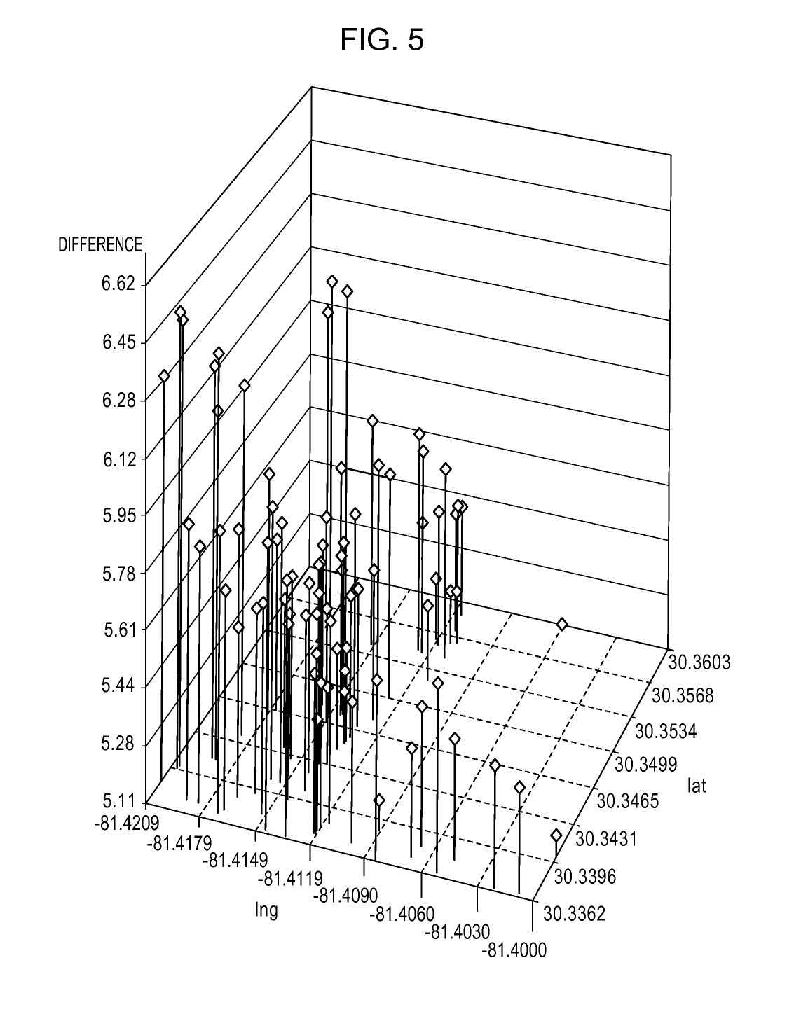

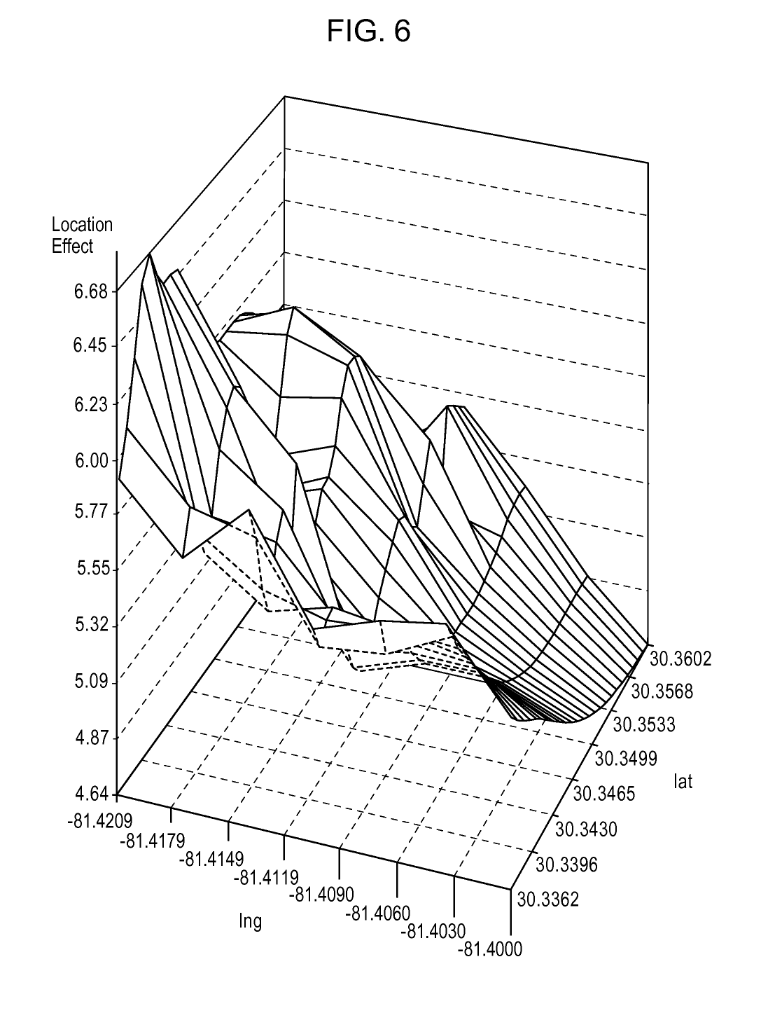

In step 308, a set of data points ID [symbol] ={D_{q}|q=1, 2, . . . Z} is generated, with Z being the total number of properties and each data point D_{q} corresponding to one of the properties. Each data point D_{q} of the set [symbol] has at least three coordinates—two coordinates for the location coordinates (x_{q},y_{q}) of the corresponding property determined in step 307, and one coordinate for the property-specific location effect λ_{q} of the corresponding property determined in step 306. Thus, an exemplary data point D_{q} for the q-th property may be expressed as (x_{q}, y_{q}, λ_{q}). FIG. 5 illustrates a graph of selected data points from the set [symbol] generated in step 308. For example, the data points illustrated in the graph of FIG. 5 may corresponds to one of the sub-regions 201.

In process step 309, a location effects function ƒᵢ(x,y) may be determined for each sub-region 201 (recall that i is an index identifying the sub-regions 201). For each sub-region 201, the location effects function may be determined by fitting a function to data points from a corresponding subset [symbol] ᵢ of the set [symbol] . The resulting location effects function ƒᵢ(x,y) should be continuous and smoothly fit to the data points. Thus, the location effects function ƒᵢ(x,y) should vary in value within the sub-region 201 according to property-level changes in location effect, unlike the sub-region average location effect values which are constant across the sub-region 201 (and hence do not vary in value within the sub-region 201 according to property-level changes in location effect). FIG. 6 illustrates an exemplary location effects function ƒᵢ(x,y). In particular, FIG. 6 illustrates a graph of the location effects function ƒᵢ(x,y) that would be generated by fitting a function to the data points of FIG. 5 (the two-dimensional function being represented by the three-dimensional surface in the graph).

For each sub-region 201, the corresponding subset [symbol] ᵢ of data points to which the location effects function ƒᵢ(x,y) is fit may include: (1) those data points D_{q} that are located in the i-th sub-region 201, and (2) those data points D_{q} that are located in at least one sub-region 201 adjacent to the i-th sub-region 201. Thus, the location effects function for any given sub-region 201 is fitted not only to the data points in that given sub-region 201, but also to data points from adjoining sub-regions 201. As discussed below, this provides an advantageous effect of smoothing out discontinuities in location effect values across sub-region boundaries.

In general, it may be desirable for the subset [symbol] ᵢ for the i-th sub-region 201 to include data points D_{q} from all of the sub-regions 201 that adjoin the i-th sub-region 201. However, when two sub-regions 201 share a significant boundary, it may be desirable to exclude data points in these sub-regions 201 from the subset [symbol] ᵢ of the adjoining sub-region. For example, if a 1^{st} sub-region 201 and a 2^{nd} sub-region 201 share a significant boundary, then it may be desirable to exclude the data points located in the 2^{nd} sub-region 201 from the subset [symbol] ₁, and similarly it may be desirable to exclude the data points located in the 1^{st} sub-region 201 from the subset [symbol] ₂. A significant boundary may be any boundary that is expected to correspond to a relatively abrupt change in the actual location effect. For example, when a sub-region boundary corresponds to a large river, a mountain, a forest, a free-way, etc., it can be expected that the actual location effect will not transition smoothly across such a boundary, and thus the boundary may be designated as significant.

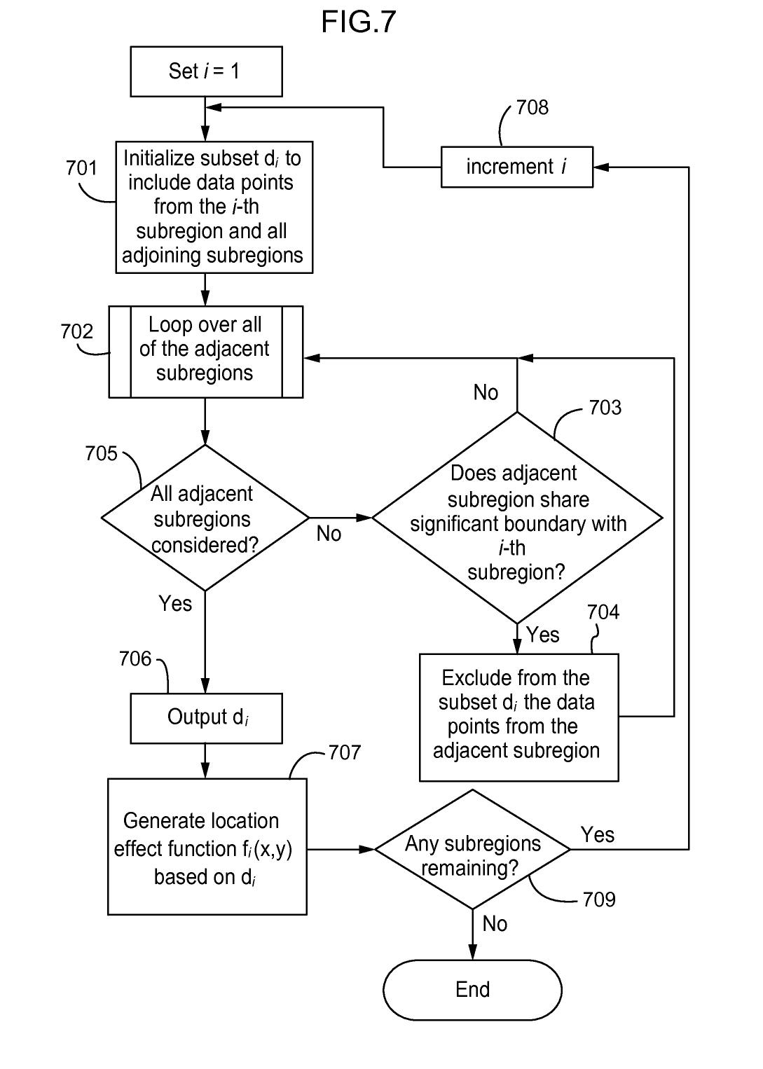

FIG. 7 illustrates an exemplary process for determining which data points to include in the subsets [symbol] ᵢ, and for determining the location effects functions ƒᵢ(x,y) based thereon.

To begin, i is set to equal 1. In process step 701, the subset [symbol] ᵢ is set to initially include data points from the i-th sub-region 201 and all adjoining sub-regions 201. Thus, for example, in the first pass through the process (i=1), the subset [symbol] ₁ is initially set to include data points from the 1^{st} sub-region 201 and all sub-regions 201 adjoining the 1^{st} sub-region 201.

In process block 702, a sub-process comprising blocks 702, 703, 704, and 705 loops over all of the sub-regions 201 that are adjacent to the i-th sub-region, considering each in turn. Thus, for example, when i=1 the sub-process loops over all of the sub-regions 201 that adjoin the 1^{st} sub-region 201, considering each in turn.

In decision block 705, it is determined whether all of the sub-regions 201 adjacent to the i-th sub-region 201 have been considered in the loop. If the answer is No (not all adjacent sub-regions 201 have been considered), then the loop is continued and the process proceeds to decision block 703 for consideration of one of the adjacent sub-regions 201. If the answer is Yes (all adjacent sub-regions 201 have been considered), then the loop is ended and the process proceeds to step 706.

In decision block 703, it is determined whether the adjacent sub-region 201 currently under consideration shares a significant boundary with the i-th sub-region 201. As noted above, a significant boundary may be any boundary that is expected to correspond to a relatively abrupt change in the actual location effects on either side thereof The determination that a boundary is a significant boundary may be done in advance by a separate process and stored in a database, in which case the determination of decision block 703 may simply comprise looking up this stored information. The determination may be made, for example, manually by a user who identifies significant boundaries based on their own judgment, or by an automated (or semi-automated) process that identifies significant boundaries by consulting a set of predetermined rules. For example, the predetermined rules may include a list of characteristics that are considered indicative of significant boundaries, and characteristics of boundaries may be compared to this list to determine whether or not the boundary in question is significant. So, for example, if the list includes the characteristic “mountain”, and a boundary under consideration corresponds to a mountain, then the boundary might be designated as significant.

If the answer in decision block 703 is No (boundary is not significant), then the loop repeats for the next adjoining sub-region 201. If the answer is Yes (boundary is significant), then the process proceeds to step 704, in which the data points from the adjacent sub-region 201 currently under consideration are excluded from the subset [symbol] ᵢ.

The sub process comprising the process blocks 702 through 705 results in the subset [symbol] ᵢ containing data points from all of the sub-regions 201 adjacent to the i-th sub-region 201 except for those sub-regions 201 sharing a significant boundary with the i-th sub-region 201, which are excluded from [symbol] ᵢ. Thus, for example, if the 1^{st} sub-region 201 is adjacent to the 2^{nd}, 3^{rd}, 4^{th} and 5^{th} sub-regions 201, and if the 1^{st} and 3^{rd} sub-regions 201 share a significant boundary, then upon completion of the sub process when i=1, the subset [symbol] ₁ for the 1^{st} sub-region 201 will include data points from properties located in the 1^{st}, 2^{nd}, 4^{th} and 5^{th} sub-regions, but will not include data points from properties located in the 3^{rd} sub-region 201.

In process step 706, [symbol] ᵢ is output.

In process step 707, a location effect function ƒᵢ(x,y) is generated for the i-th sub-region 201 based on the output subset [symbol] ᵢ, by fitting a function to the data points of the output subset [symbol] ᵢ in the manner discussed above.

In decision block 709, it is determined whether there are any sub-regions 201 remaining for which a location effect function ƒᵢ(x,y) has not yet been determined. If the answer is Yes, then the process returns to step 701 after first incrementing the value of i in step 708, thus beginning the process again for the next sub-region 201. If the answer is No (i.e., all sub-regions 201 have location effect functions ƒᵢ(x,y)), then the process ends.

For each of the sub-regions 201, the fitting of the function to the subset of data points [symbol] ᵢ may be done by any convenient statistical method for fitting a function to a set of data, such as a generalized additive regression, or any other non-parametric locally smoothing regression. Under the assumption of a nonparametric smoothing two-dimensional spline across both the latitude and longitude directions, the resulting fitted function can take into account the vast variation in location effect from one property to another for each small geographic unit in every market, and thus ensure a close fit to the actuality of local real estate market environment. The fitting results in generation of the location effects function ƒᵢ(x,y) for the i-th sub-region 201 that is continuous at least within the i-th sub-region 201, and that varies within the i-th sub-region 201 according to property-level changes in location effect.

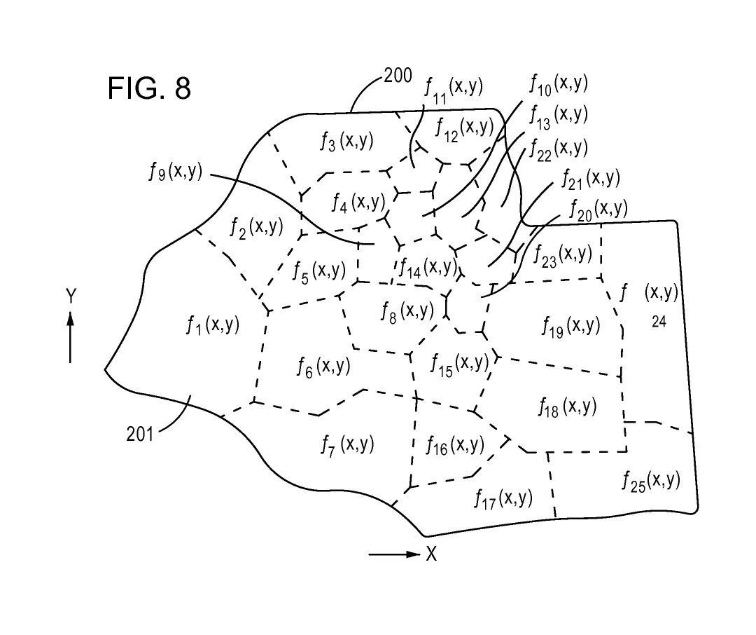

At the conclusion of process step 309, each sub-region 201 will have its own location effects function ƒᵢ(x,y), as illustrated in FIG. 8. The location effects functions ƒᵢ(x,y) output a measure of location effect as a function of location. The measure of location effect that the location effects functions ƒᵢ(x,y) outputs may be either a marginal location effects value, or an absolute location effects value, depending on whether the property-level location effect values λ_{q} determined in step 306 represent marginal values or absolute values. If the location effects functions ƒᵢ(x,y) output absolute location effects values, then the total location effect for a location is simply given by the output of the location effects functions ƒᵢ(x,y) for that location—thus, for example, if a given location (x₀,y₀)is located in the 3^{rd} sub-region 201, the absolute location effect for the given location would be given by ƒ₃(x₀,y₀). If, on the other hand, the location effects functions ƒᵢ(x,y) output marginal location effects values, the absolute location effects value can be obtained simply by adding the sub-region average location value l̅ᵢ to the marginal location effects values output by the function ƒᵢ(x,y)—thus, for example, the absolute location effect value for the given location (x₀,y₀) that is located in the 3^{rd} sub-region 201 would be given by ƒ₃(x₀,y₀)+l̅₃.

Because the location effects functions ƒᵢ(x,y) are continuous and allowed to vary according to property-level changes in location effect, the location effects functions ƒᵢ(x,y) should estimate the actual location effects throughout their corresponding sub-region 201 very well. Thus, at every location within the i-th sub-region 201, the values of the location effects function ƒᵢ(x,y) (estimated location effect values) for any given location should be very close to the actual location effect values for the given location. This means that the location effects functions ƒᵢ(x,y) will reflect intra-sub-regional changes in location effect, unlike the sub-region average location effect approach which cannot account for such intra-sub-regional changes in location effect. Accordingly, the present approach results in much more accurate estimations of location effects within each sub-region 201 than the sub-region average location effect approach (and hence more accurate estimations of overall property value).

In addition, because the location effects function ƒᵢ(x,y) for the i-th sub-region 201 was generated by fitting both the data points located within the i-th sub-region 201 and also the data points from adjacent sub-regions 201, the problem of abrupt discontinuities at sub-region 201 boundaries can be eliminated. For example, assuming that the 3^{rd} and 4^{th} sub-regions 201 adjoin each other, the location effects function ƒ₃(x,y) for the 3^{rd} sub-region 201 will very closely match the location effects function ƒ₄(x,y) for the 4^{th} sub-region 201 at the boundary between the two sub-regions 201, such that there is no abrupt discontinuity at the boundary. This is because the subset [symbol] ₃ (used to fit the location effects function ƒ₃(x,y)) and the subset [symbol] ₄ (used to fit the location effects function ƒ₄(x,y)) both include the same data points from the 3^{rd} and the 4^{th} sub-regions 201.

Of course, when it is said that no abrupt discontinuity exists at the boundary, this does not mean to imply an exact mathematical match at the boundary. The values of adjoining location effects functions ƒᵢ(x,y) at the boundary may be slightly different from each other. In other words, if (x₀, y₀) is an arbitrary point on the boundary between the 3^{rd} and the 4^{th} sub-regions 201, then |ƒ₄ (x₀, y₀)−ƒ₃ (x₀, y₀)|≦ε, where ε is some number that is not necessarily zero. This is because, although the functions are fit to some of the same data points (shared data points), the respective functions are also based on some non-shared data points (e.g., data points from sub-regions that adjoin one of the sub-regions under consideration but not the other), and thus the functions are not necessarily identical.

However, because the shared data points are closer to the boundary, they will influence the fittings of the functions locally near the boundary more strongly than the non-shared data points that are distant from the boundary will, and therefore the functions, although not identical, will be very similar near the boundaries. In other words, ε will be sufficiently small that it is negligible for all practical purposes. In general, the difference in values between location effects functions of adjoining sub-regions at any given boundary point will be less than around 1 to 10 basis points—in other words ε will generally be less than around a couple hundred dollars. Thus, the values of adjoining functions ƒᵢ(x,y) are close enough to each other at the boundary that any jump in values at the boundary is statistically insignificant. Furthermore, any difference in values between adjacent location effects functions ƒᵢ(x,y) at their shared boundary should be less than the difference in adjacent sub-region average location effect values l̅ᵢ at the same boundary, and moreover in most cases will be significantly less. Thus, to continue the example from above, ε<|l̅₄−l̅₃| should be true in all but the most anomalous cases, and in most cases ε<<|l̅₄−l̅₃| should be true. Thus, the above approach should completely eliminate the problem of abrupt discontinuities at sub-region boundaries for all practical purposes, and at the very least will greatly improve the situation as compared to the sub-region average location effect approach.

Once location effect functions have been determined for each sub-region 201, these functions can be used to estimate location effects at the property-level of any arbitrary location with the region 200. For example, if a given location having coordinates (x₀, y₀) is located in the 4^{th} sub-region 201, then the location effect of the given location can be estimated by ƒ₄(x₀,y₀)—that is, the location coordinates of the given location can be plugged into the location effects function ƒ₄(x,y) and the resulting value is the estimated location effect for that given location. Because the location effects functions are functions of location coordinates independent of any other property information, the location effects functions can estimate location effects for locations whose properties were not included in the property data, or even for locations that do not have a property associated therewith.

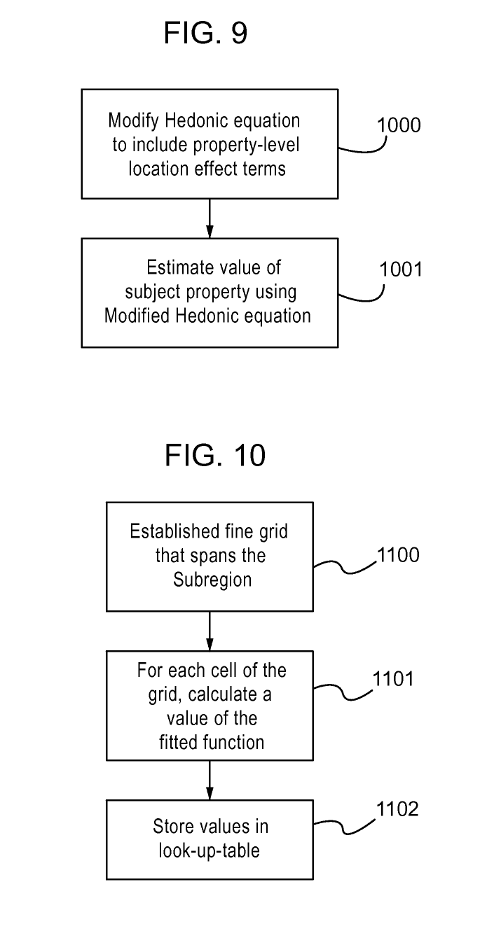

The property-level location effects estimated by the location effects functions can be used in a variety of ways. For example, as illustrated in FIG. 9, a new Hedonic equation may be generated that relies upon the property-level location effects estimated by the location effects functions instead of (or in addition to) other measures of location effect. In step 1000, the Hedonic equation discussed above may be modified to include property-level location effect terms based on the location effect functions ƒᵢ(x,y). In step 1001, the value of a subject property may be estimated by using the modified hedonic equation.

The modification to the Hedonic equation may be simply adding new property-level location effect terms thereto (and leaving the sub-region average location fixed effect variable L̅O̅C̅ᵢ terms intact), or it may also comprise removing the sub-region average location fixed effect terms. In particular, when the location effects functions ƒᵢ(x,y) output marginal location effect values, if may be desirable to keep the sub-region average location fixed effect terms L̅O̅C̅ᵢ, since the combination of the sub-region average location effect l̅ᵢ and the marginal property-level location effect calculated by the location effects functions ƒᵢ(x,y) corresponds to the absolute location effect for the given location. On the other hand, when the location effects functions ƒᵢ(x,y) output absolute location effect values, it may be desirable to remove the sub-region average location effect terms entirely L̅O̅C̅ᵢ. In either case, the resulting modified hedonic equation uses property-level location effects to estimate property values, and thus will be much more accurate than it was before being modified.

The property-level location effect terms added to the hedonic equation may comprise one term for each of the location effects functions ƒᵢ(x,y). However, the terms may be established in such a manner that only the location effects function for the sub-region 201 in which a subject property is located is used in estimating the value of the subject property. For example, when the subject property is located in the i-th sub-region 201, then all of the property-level location effect terms other than the i-th function ƒᵢ(x,y) may be set to zero, and the location of the subject property may be inputted into the i-th function ƒᵢ(x,y) to calculate a property-level location effect value.

In addition, instead of storing the location effect functions ƒᵢ(x,y) in analytic form, it may be desirable in certain applications to store in a look-up table discrete calculated values of the location effect functions ƒᵢ(x,y) for a predetermined set of locations. For example, a fine grid may be established that spans each of the sub-regions 201 as indicated in step 1100 of FIG. 10. The values of the location effects functions ƒᵢ(x,y) may be calculated at each cell of the grid, as indicated in step 1101 of FIG. 10. These values may then be stored in a look-up table as indicated in step 1102 of FIG. 10. Doing so may reduce the processing resources required to respond to future requests for determining location effect values for a given location. In particular, instead of having to go through the potentially processor-intensive process of calculating a value of the function ƒᵢ(x,y) at the given location, a comparatively simple process of looking up a value corresponding to that given location in a lookup table may be performed (for example, the value stored in association with the grid cell that encompasses the given location may be looked up). Of course, the same number of calculations are ultimately done, and thus the total processing load is not necessarily reduced; however, because the calculations are done in advance, the time it takes to respond to user requests for information received at a later date can be greatly reduced.

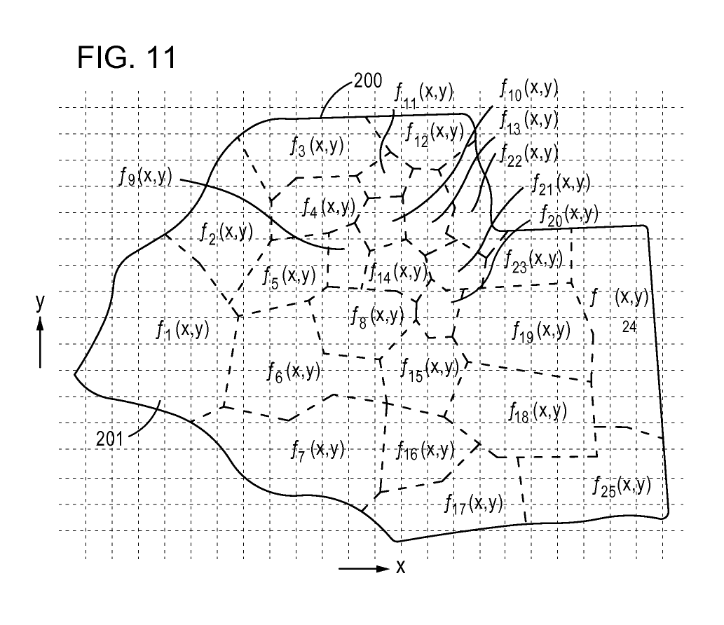

FIG. 11 illustrates an exemplary gridding of the region 200. In the figure, a regular rectilinear grid is used in which each cell is rectangular in shape and the same size. However, any type of tessellation may be used as the gridding, including tessellations in which cells (or tiles) have irregular shapes and/or sizes. The gridding may be as fine or coarse as desired, and no gridding method is prohibited or prescribed. However, preferably the gridding is sufficiently fine so as not to lose the property-level variation in location effect that the continuous functions ƒᵢ(x,y) model. In other words, one of the benefits of the continuous functions ƒᵢ(x,y) is that they model changes in location effect that occur at the property-level, and it is preferable that this benefit not be lost by discretizing the functions. This can be accomplished by using a cell granularity that, in general, keeps the distance between adjacent cell in the range of the typical distance between neighboring houses in the local area. In other words, the cell granularity is determined based on the local density of properties (or some proxy thereof) such that the distributions of cells in the grid approximately matches the distribution of properties in the local area. Doing so ensures that any variation in location effect occurring at the property-level will still be modeled by the discretized data because the data was sampled at approximately the property-level. As such, the only information that will be lost by the discretization will be variations in location effect that occur at levels lower than property-level; however, location effects are not expected, in general, to vary significantly at levels lower than property-level, and therefore the loss of information regarding such variations will be insignificant for all practical purposes. When the grid granularity is determined by this approach, then the grid will be rather dense (fine) in densely populated neighborhoods (e.g., urban areas), and rather sparse (coarse) in sparsely populated areas (e.g., rural areas). This is beneficial because it is a waste of resources to calculate location effect values at high cell-densities in sparsely populated regions.

Some examples of how to determine cell granularity based on property density (or a proxy thereof) so as to approximately match the distribution of cells to the distribution of properties are provided below, but it will be understood that any method of determining cell granularity that preservers property-level variations in location effect may be used. For example, the number of properties in a predetermined area (e.g., a sub-region 201) may be determined and the number of cells in the area may be set to be equal to or greater than the number of properties in the area. As another example, the number of properties in a predetermined area may be determined and the number of cells in the area may be set to be equal to or greater than a number that is proportional to the number of properties in the area (e.g., number of cells is equal-to or greater-than ¾ the number of properties in the area). As another example, the gridding may be made sufficiently fine that each cell of the grid corresponds to an area roughly equivalent to a typical lot size. The typical lot size may be determined, for example, with reference to local zoning regulations. The typical lot size may be determined on a per-sub-region 201 basis, for the entire region 200, or based on some other geographical or political division. As another example, the gridding may be made sufficiently fine that the centers of two adjacent cells are roughly proportional to property line setbacks defined by local regulations (e.g., no more than twice the property line setbacks, which will generally be around 0.05 miles to 0.1 miles). As another example, the gridding may be made sufficiently fine that each cell contains no more than a predetermined number of properties from the property data (e.g., no more than two properties). All of these exemplary standards for determining cell granularity determine cell granularity based on property density (or a proxy thereof), and are calculated to ensure that property-level variation in location effect is still reflected in the discretized functions.

It will be understood that “property density” as used in the appended claims includes proxies for property density, as well as an actual property density. Proxies for property density include any measures relatable to property density, including, for example, distance between properties, area of properties, number of properties per predetermined unit of area, number of properties per cell, etc.

Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A non-transitory computer readable medium that stores program code that is configured to, when executed by a computing system, cause the computing system to perform operations comprising:
accessing property data that describes properties located in a geographic region that includes various sub-regions;
determining, based on the property data, a regression function that models a relationship between sale price and a set of explanatory variables;
determining an estimated value for each of the properties by using the regression function;
determining a property-level location effect for each of the properties based on a difference between the estimated value determined for the respective property and a realized sale price of the respective property;
determining, for each of the properties, a location effect data point that includes coordinates that specify a location of the respective property and the property-level location effect determined for the respective property;
determining, for each of the sub-regions, a property-level location effect function that relates location effect as a dependent variable to one or more independent variables that specify location by regressing over the location effect data points of at least those of the properties that are located in the respective sub-region, the property-level location effect function varying in value within the respective sub-region.

2. The non-transitory computer readable medium of claim 1, wherein the operations further comprise:
determining a property-value estimating function by modifying the regression function to include one or more terms corresponding to the property-level location effect functions of the sub-regions; and
estimating a value of a property that is in the geographic region using the property-value estimating function.

3. The non-transitory computer readable medium of claim 1, wherein the operations further comprise:
determining an estimated property-level location effect for a given property located in a given one of the sub-regions by calculating a value of the property-level location effect function for the given one of the sub-regions at a location of the given property.

4. The non-transitory computer readable medium of claim 1, wherein the operations further comprise:
determining a grid covering the geographic region,
determining, for each cell of the grid, a value of the property-level location effect function for the sub-region in which the cell is located.

5. The non-transitory computer readable medium of claim 4, wherein the operations further comprise:
determining an estimated property-level location effect for a given property located in a given one of the sub-regions by identifying a cell of the grid that corresponds to the given property and returning the determined value for the corresponding cell as the estimated property-level location effect for the given property.

6. The non-transitory computer readable medium of claim 4, wherein a granularity of the grid is determined based on a measure of property-density in the geographic region.

7. The non-transitory computer readable medium of claim 6, wherein, for each of the sub-regions, the property-level location effect function of the respective sub-region defines a continuous surface at least within the sub-region that spans the respective sub-region.

8. The non-transitory computer readable medium of claim 1, wherein, for each of the sub-regions, the property-level location effect function of the respective sub-region defines a continuous surface at least within the sub-region that spans the respective sub-region.

9. The non-transitory computer readable medium of claim 1, wherein, for a given one of the sub-regions, the property-level location effect function for the given one of the sub-regions is determined by regressing over the location effect data points of the properties that are located in at least one of the sub-regions that is immediately adjacent to the given one of the sub-regions in addition to data points of the properties that are located in the given one of the sub-regions.

10. The non-transitory computer readable medium of claim 1, wherein the operations further comprise:
for each of the sub-regions, determining whether the boundaries between the respective sub-region and the sub-regions immediately adjacent to the respective sub-region are significant boundaries,
wherein, for each of the sub-regions, the property-level location effect function for the respective sub-region is determined by regressing over the location effect data points of each of the properties that is located in any one of the sub-regions that is immediately adjacent to the respective the sub-region, except for properties that are located in a sub-region that is immediately adjacent to the respective sub-region and that shares a significant boundary therewith.

11. The non-transitory computer readable medium of claim 1, wherein the regression function includes a sub-region-level location fixed effect variable.

12. A method comprising:
accessing property data that describes properties located in a geographic region that includes various sub-regions;
determining, based on the property data, a regression function that models a relationship between sale price and a set of explanatory variables;
determining an estimated value for each of the properties by using the regression function;
determining a property-level location effect for each of the properties based on a difference between the estimated value determined for the respective property and a realized sale price of the respective property;
determining, for each of the properties, a location effect data point that includes coordinates that specify a location of the respective property and the property-level location effect determined for the respective property;
determining, for each of the sub-regions, a property-level location effect function that relates location effect as a dependent variable to one or more independent variables that specify location by regressing over the location effect data points of at least those of the properties that are located in the respective sub-region, the property-level location effect function varying in value within the respective sub-region.

13. The method of claim 12, further comprising:
determining a property-value estimating function by modifying the regression function to include one or more terms corresponding to the property-level location effect functions of the sub-regions; and
estimating a value of a property that is in the geographic region using the property-value estimating function.

14. The method of claim 12, further comprising:
determining an estimated property-level location effect for a given property located in a given one of the sub-regions by calculating a value of the property-level location effect function for the given one of the sub-regions at a location of the given property.

15. The method of claim 12, further comprising:
determining a grid covering the geographic region,
determining, for each node of the grid, a value of the property-level location effect function for the sub-region in which the node is located.

16. The method of claim 15, further comprising:
determining an estimated property-level location effect for a given property located in a given one of the sub-regions by identifying a node of the grid that corresponds to the given property and returning the determined value for the corresponding node as the estimated property-level location effect for the given property.

17. The method of claim 15, wherein a granularity of the grid is determined based on a measure of property-density in the geographic region.

18. The method of claim 17, further comprising:
wherein, for each of the sub-regions, the property-level location effect function of the respective sub-region defines a continuous surface at least within the sub-region that spans the respective sub-region.

19. The method of claim 12, further comprising:
wherein, for each of the sub-regions, the property-level location effect function of the respective sub-region defines a continuous surface at least within the sub-region that spans the respective sub-region.

20. The method of claim 12, wherein, for a given one of the sub-regions, the property-level location effect function for the given one of the sub-regions is determined by regressing over the location effect data points of the properties that are located in at least one of the sub-regions that is immediately adjacent to the given one of the sub-regions in addition to data points of the properties that are located in the given one of the sub-regions.

21. The method of claim 12, further comprising:
for each of the sub-regions, determining whether the boundaries between the respective sub-region and the sub-regions immediately adjacent to the respective sub-region are significant boundaries,
wherein, for each of the sub-regions, the property-level location effect function for the respective sub-region is determined by regressing over the location effect data points of each of the properties that is located in any one of the sub-regions that is immediately adjacent to the respective the sub-region, except for properties that are located in a sub-region that is immediately adjacent to the respective sub-region and that shares a significant boundary therewith.

22. The method of claim 12, wherein the regression function includes a sub-region-level location fixed effect variable.
